(19) United States
(12) Patent Application Publication
(10) Pub. No.: US 2025/0244054 A1
(43) Pub. Date: Jul. 31, 2025

(54) Test Chamber And Method For Control

(71) Applicant: Weiss Technik GmbH, Reiskirchen (DE)

(72) Inventors: Johannes Teichmann, Geislingen (DE); Tobias Heckele, Balingen (DE)

(21) Appl. No.: 19/034,862

(22) Filed: Jan. 23, 2025

(30) Foreign Application Priority Data
Jan. 26, 2024 (EP) 24154096.2

(51) Int. Cl. F25B 9/10; F25B 9/00; G01M 99/00

(52) U.S. Cl. CPC F25B 9/10; F25B 9/008; G01M 99/002

(57) ABSTRACT

A test chamber and a method for conditioning air in a temperature-insulated test space of the test chamber, the test space being sealable and configured to receive test materials, a cooling element of a temperature-control device of the test chamber, a first cooling circuit having a first refrigerant, a heat exchanger in the test space, a compressor, a gas cooler, a cascade heat exchanger and an expansion valve yielding a temperature ranging from −20° C. to +150° C. within the test space, the cascade heat exchanger being connected to a high-pressure side of the first cooling circuit, the cascade heat exchanger being coupled with a second cooling circuit of the cooling element, the temperature in the test space being controlled and/or regulated by a control device of the test chamber. The first refrigerant is an unfluorinated refrigerant and the second cooling circuit comprising a pump and a liquid as a heat carrier.

### CROSS-REFERENCE TO RELATED APPLICATIONS

This patent application claims priority to European Patent Application No. 24154096.2 filed on Jan. 26, 2024, the contents of which are incorporated herein by reference in its entirety for all purposes.

### TECHNICAL FIELD

This disclosure relates to a test chamber and a method for conditioning air in a temperature-insulated test space of the test chamber, in particular a climate chamber, the test space being sealable against an environment and configured to receive test materials, a cooling element of a temperature-control device of the test chamber, a first cooling circuit having a first refrigerant, a heat exchanger in the test space, a compressor, a gas cooler, a cascade heat exchanger and an expansion valve yielding a temperature ranging from −20° C. to +150° C. within the test space, the cascade heat exchanger being connected to a high-pressure side of the first cooling circuit, the cascade heat exchanger being coupled with a second cooling circuit of the cooling element, the temperature in the test space being controlled and/or regulated by a control device of the test chamber.

### BACKGROUND

Such test chambers are regularly used to test the physical and/or chemical properties of objects, in particular devices. Hence, temperature test chambers or climatic test chambers are known within which temperatures ranging from −50° C. to +150° C. can be set. In climatic test chambers, additional desired climatic conditions can also be set, to which the device and/or the test materials are then exposed over a defined period of time. The temperature of a test space receiving the test materials to be tested is regularly controlled in an air-circulation duct within the test space. The air-circulation duct forms an air-treatment space in the test space, in which heat exchangers are disposed to heat or cool the air flowing through the air-circulation duct and/or the test space. A fan and/or ventilator draws in the air in the test space and directs it in the air-circulation duct to the corresponding heat exchangers. The test materials can thus be controlled in temperature or be exposed to a defined temperature change. During a test interval, for example, a temperature can change between a maximum temperature and a minimum temperature in the test chamber. A test chamber of this type is known, for example, from EP 0 344 397 A2.

In order to meet the high requirements for temperature control within the temperature range of the test space using such cooling elements and to avoid fluctuations in a load requirement, the cooling element can also be designed in the form of a two-stage refrigerating plant. In a two-stage refrigerating plant, a first cooling circuit and a second cooling circuit are each coupled and/or connected via a common cascade heat exchanger, a heat exchanger of the first cooling circuit being used for temperature control in a test space of the test chamber. The second cooling circuit is used to cool and/or condense the refrigerant of the first cooling circuit when a high cooling load is required.

The refrigerant used in a cooling circuit should have a relatively low CO₂ equivalent, i.e., a relative global warming potential (GWP) should be as low as possible in order to avoid indirect damage to the environment by the refrigerant when released. Due to legal regulations, a refrigerant must not contribute significantly to ozone depletion in the atmosphere or global warming.

It is also known to use hydrocarbons as refrigerants, although the disadvantage is that hydrocarbons are highly flammable. Flammability is understood here as the property of the refrigerant to react with ambient oxygen, while releasing heat. A refrigerant is particularly flammable if it falls into fire class C according to the European standard DN 2 and/or DIN 378 classes A2, A2L and A3 in the version last valid on the priority date.

Essentially, no fluorinated gases or fluorinated substances should be used as refrigerants, for which reason natural refrigerants, such as carbon dioxide (CO₂), come into consideration. The disadvantage of such refrigerants having low GWP is that in the temperature ranges relevant for a cooling circuit, these refrigerants sometimes have a significantly reduced cooling capacity compared to refrigerants having comparatively higher GWP. A low GWP can be achieved with refrigerant mixtures which have a comparatively high mass fraction of carbon dioxide, these refrigerant mixtures having zeotropic properties due to the different substances mixed, which in turn is undesirable in many cooling circuits. Moreover, the proportion of carbon dioxide must be so high that the refrigerant is not flammable. For example, WO 2019/048250 A1 describes a test chamber having a refrigerant which essentially consists of carbon dioxide, pentafluoroethane and difluoromethane. The disadvantage here is that the refrigerant must be subcooled by an internal heat exchanger in a cooling circuit in order to achieve particularly low temperatures. Furthermore, the refrigerant has zeotropic properties and contains fluorinated gases as components.

Due to the very high cooling capacity of carbon dioxide, the problem is that climatic tests can only be carried out to a limited extent. A defined relative air humidity and temperature must be yielded in the test space. Among other things, this also requires dehumidification of the air in the test space if, for example, the air in the test space is cooled during a test cycle. When the air is being cooled, condensation on the heat exchanger is difficult to control, particularly due to the high cooling capacity, which can lead to unwanted dehumidification of the air in the test space. Furthermore, dehumidification may also be too low if, for example, only a very slow, defined temperature change is planned as part of a test cycle. With a cooling element of this type, it is therefore not always possible to carry out a climatic test cycle with satisfactory accuracy.

### SUMMARY

The object of the disclosure at hand is therefore to propose a method for conditioning air in a test space of a test chamber as well as a test chamber, both of which are environmentally friendly and allow efficiently conducting climatic tests.

This object is attained by a method having the features described herein, a test chamber having the features described herein and a system having the features described herein.

In the method according to the disclosure for conditioning air in a temperature-insulated test space of a test chamber, in particular a climate chamber, the test space being sealable against an environment and configured to receive test materials, a cooling element of a temperature-control device of the test chamber, a first cooling circuit having a first refrigerant, a heat exchanger in the test space, a compressor, a gas cooler, a cascade heat exchanger and an expansion valve yield a temperature ranging from −20° C. to +150° C. within the test space, the cascade heat exchanger being connected to a high-pressure side of the first cooling circuit, the cascade heat exchanger being coupled with a second cooling circuit of the cooling element, the temperature in the test space being controlled and/or regulated of a control device of the test chamber, the first refrigerant being an unfluorinated refrigerant, preferably pure carbon dioxide, the second cooling circuit comprising a pump and a liquid as a heat carrier, the temperature being yielded within the test space.

In accordance with the disclosure, the cooling element is designed in the manner of an at least two-stage refrigerating plant; however, the heat carrier is used instead of a second refrigerant in the second cooling circuit and the pump is used instead of a compressor. In principle, it is intended for the heat carrier to be circulated in the second cooling circuit by the pump. The heat carrier also flows through the cascade heat exchanger, through which the first refrigerant flows. The first refrigerant is then cooled and/or desuperheated at the cascade heat exchanger so that any thermal energy generated at the cascade heat exchanger can be dissipated by the second cooling circuit and the first refrigerant cooled in this manner can be directed to the heat exchanger in the test space. The heat exchanger is thus cooled and the thermal energy generated at the heat exchanger in the test space is thus removed via the first cooling circuit, which is operated using the first refrigerant, which is an unfluorinated refrigerant, preferably pure carbon dioxide. Pure carbon dioxide has a GWP of 1, is non-flammable, non-hazardous and available at low cost. In addition, carbon dioxide is a pure and/or azeotropic substance, thus making the advantageous implementation of the method in its variations possible in the first place. It is also possible to ensure a comparatively temperature-stable liquefaction of the first refrigerant in the cascade heat exchanger via the heat carrier of the second cooling circuit. In addition, the second cooling circuit can be designed to be particularly simple and cost-effective, as only one pump is required to circulate the heat carrier. A pump of this type is comparatively less sensitive to a high number of switching cycles than a compressor, so that the second cooling circuit can be operated as required and with comparatively low energy consumption. Furthermore, the pump can be operated comparatively quietly compared to the compressor, which can reduce unwanted noise emissions. Overall, the method for operating the test chamber therefore enables environmentally friendly and safe operation of the test chamber as well as simple adaptation of the cooling element to a wide range of operating requirements with low energy consumption.

In this manner, the heat carrier can be circulated in the second cooling circuit without a phase change. A pressure of the heat carrier in the second cooling circuit, for example around 1 MPa, can be yielded between an inlet flow and a return flow of the second cooling circuit at a comparatively low pressure difference, for example 10 kPa to 50 kPa. The pressure difference can vary due to flow resistance and/or thermal expansion in the second cooling circuit. For example, brine, oil or another suitable liquid can be used as the heat carrier.

The second cooling circuit can have a valve element, preferably a three-way valve, between an inlet flow and a return flow of the second cooling circuit, the valve element bridging the cascade heat exchanger, a regulating element of the control device being able to regulate a mass flow to the heat carrier via the cascade heat exchanger by the valve element. Alternatively, the valve element can also be formed from a number of magnetic valves, which are controlled by the control device and via which a flow of the heat carrier can be regulated. If the valve element is designed having a three-way valve, this can be disposed in the second cooling circuit downstream of the cascade heat exchanger and upstream of the pump in the flow direction. The inlet flow, starting from the pump in the flow direction of the heat carrier to the cascade heat exchanger, can then be connected to the three-way valve. By the three-way valve, the cascade heat exchanger can be optimally pressurized with the heat carrier, whereby a very high regulating precision can be achieved, as the three-way valve does not have to be completely closed. For example, the three-way valve can be easily controlled via a motor, a stepper motor or other actuators, and thus a ratio of a volumetric flow rate and/or mass flow between the inlet flow and the return flow via the three-way valve and between the inlet flow and the return flow via the cascade heat exchanger can be optimally adjusted depending on the operating requirements.

A liquid bypass can be formed in the second cooling circuit between an inlet flow and a return flow of the second cooling circuit, the liquid bypass being able to extend via the heat exchanger, the temperature in the test space being able to be yielded by the first cooling circuit and/or the second cooling circuit. The liquid bypass consequently extends through the test space and/or the heat exchanger disposed therein, so that the liquid bypass of the second cooling circuit can also be used to influence the temperature in the test space. Depending on the temperature to be yielded in the test space, the second cooling circuit can be operated using the liquid bypass, for example if a comparatively high temperature, such as −10° C., is to be formed as constantly as possible. Alternatively, the first cooling circuit can also be operated on its own if a rapid temperature change is required. The first cooling circuit and the second cooling circuit can also be operated simultaneously, with or without the liquid bypass, if particularly low temperatures are to be set in the test space. In this case, it can also be intended to use the liquid bypass, at least within suitable temperature ranges. A change in the operation of the first cooling circuit and the second cooling circuit requires a particularly precise regulation so that there is no undesirable change in temperature in the test space as a result of the change.

The liquid bypass can have a bypass valve element, preferably a bypass three-way valve, between an inlet flow and a return flow of the liquid bypass, the bypass valve element being able to bridge the heat exchanger, a regulating element of the control device being able to regulate a mass flow of the heat carrier via the heat exchanger by the bypass valve element. The bypass valve element can be formed by a number of magnetic valves or, for example, a three-way valve. In the flow direction of the heat carrier, the liquid bypass can be connected in the inlet flow downstream of the pump and upstream of the cascade heat exchanger and in the return flow downstream of the cascade heat exchanger and upstream of the pump. If the bypass valve element is formed by a bypass three-way valve, the bypass three-way valve can be disposed in the inlet flow or the return flow of the liquid bypass. In this context, a tube connection can be provided from the inlet flow to the return flow to or from the bypass three-way valve, by which the heat exchanger can be bridged. The bypass valve element can now be used to regulate a supply of the heat carrier to the heat exchanger and/or a mass flow of the heat carrier through the heat exchanger. This enables a particularly precise temperature regulation of a temperature in the test space.

Another pump by which the heat carrier can be conveyed can be disposed in the liquid bypass. The additional pump can be disposed in the inlet flow or the return flow of the liquid bypass. This makes it possible to achieve an even more improved temperature control, as the additional pump can be used to yield a continuous mass flow of the heat carrier, which can be easily throttled using the bypass valve element. Any hydraulic unevenness within the second cooling circuit can thus be avoided.

The expansion valve and/or a three-way valve each having a PID controller of a regulating element of the control device can be regulated according to a temperature in the test space as a reference variable. In principle, it is also possible to use other suitable regulators. In particular, each of the valves and/or throttles mentioned can be regulated using a dedicated regulator of the regulating element. The regulating element can be designed in such a manner that the corresponding regulators are combined in a cascade regulator of the regulating element. These valves can be controlled by suitable actuators, for example a stepper motor. The cascade regulator can then regulate according to a temperature in the test space, which can be specified by the control device, as a reference variable.

The control device can operate the pump at a temperature of >0° C. in the test space as a reference variable and the compressor at a temperature of <0° C. In the heat carrier, a temperature of, for example, −20° C. to 0° C. can be reached in an inlet flow of the second cooling circuit. The second cooling circuit is therefore particularly suitable if constant temperatures of <0° C. or temperature changes with small gradients are to be yielded in the test space. For lower temperatures of up to −50° C., on the other hand, the first cooling circuit is suitable, for example if carbon dioxide is used as the first refrigerant. This comparatively low temperature can be advantageously yielded using carbon dioxide. The first cooling circuit can therefore be used advantageously for temperatures of <0° C., temperature changes with large gradients or requirements with high heat compensation. The second cooling circuit can also be used to liquefy the first refrigerant in the first cooling circuit. In this case, the compressor and the pump are operated simultaneously. For example, an inlet-flow temperature of the heat carrier can be 5 K to 10 K lower than a temperature required for liquefaction of the first refrigerant. As has been shown, a spatial distribution of climatic and temperature conditions can be made particularly homogeneous and stable by operating the second cooling circuit.

A rotational speed of the compressor and/or the pump can be controlled. The compressor and/or the pump can each be designed having a frequency converter which allows a rotational speed adjustment of the compressor and/or the pump. Regulation can take place by a PID controller of a regulating element of the control device. By lowering the rotational speed, a mass flow of the first refrigerant and/or the second refrigerant can be reduced in a partial-load operating state of the corresponding cooling circuit, thus further increasing the efficiency of the corresponding cooling capacity in this operating state. Furthermore, a rotational-speed regulation of the compressor enables the rotational speed of the compressor to be increased and decreased by the control device in such a manner that a suction-gas pressure on a low-pressure side of the first cooling circuit can be changed and can thus be adapted in a desired manner.

The first cooling circuit can be operated in a thermodynamically subcritical or transcritical operating state. Depending on the cooling-load demand within the test space, the operating state can be changed accordingly using the control device. During subcritical operation of the first cooling circuit, the first refrigerant is liquefied in the gas cooler and/or desuperheater and/or in the cascade heat exchanger below the critical point of the first refrigerant and expanded at the expansion valve and converted into the gaseous phase or wet vapor. The compressor and the pump can be operated at least in the subcritical operating state or at low ambient temperatures. The subcritical operating state of the first cooling circuit corresponds to a partial-load operation. In the transcritical operating state, the first refrigerant circulates in the first cooling circuit essentially in a gaseous state. This means that a temperature difference is reduced to such an extent that the first refrigerant is not liquefied in the gas cooler or in the cascade heat exchanger. A pressure above the critical point of the first refrigerant at the gas cooler and/or cascade heat exchanger is also reached in the transcritical operating state. If, for example, there is a high cooling-load demand, the cooling circuit can be operated transcritically. If there is a low cooling-load demand within the test space, for example if a temperature is to be kept constant or if ambient temperatures are low, the cooling circuit can be operated subcritically.

A bypass having at least one bypass expansion valve can be formed in the first cooling cycle, the bypass being able to extend via the heat exchanger and being able to be connected to the high-pressure side of the first cooling cycle downstream of the gas cooler or the cascade heat exchanger and upstream of the expansion valve in the flow direction and to a low-pressure side of the first cooling cycle downstream of the heat exchanger and upstream of the compressor in the flow direction, the temperature in the test space being able to be regulated in such manner that first refrigerant can be metered in the heat exchanger via the bypass expansion valve. The bypass of the first cooling circuit can be used particularly advantageously when there is a high cooling-load demand.

Air in the test space can be dehumidified by a dehumidifier bypass, the first cooling cycle having a dehumidifier expansion valve or the second cooling cycle having a dehumidifier valve element, preferably a dehumidifier three-way valve, and having a dehumidifier heat exchanger in the test space. This dehumidification can take place at a specific point in time during a test cycle, in particular whenever a temperature in the test space is within a range of >0° C. to <100° C. If a temperature below or above this range is formed within the test space, no water can precipitate in the liquid phase at the dehumidifier heat exchanger, so that the dehumidifier bypass does not function in these areas. Accordingly, the first cooling circuit of the cooling element can be designed in such a manner that the temperature of −20° C. to +180° C. can be yielded within the test space as part of a test cycle, the air being dehumidified by the dehumidifier bypass only in a partial range of this temperature range. The dehumidification then takes place in such a manner that the first refrigerant is metered from the high-pressure side of the first cooling circuit to a low-pressure side of the first cooling circuit using the dehumidifier expansion valve. This results in cooling of the dehumidifier heat exchanger, which is disposed in the dehumidifier bypass downstream of the dehumidifier expansion valve in a flow direction of the first refrigerant. The control device can now meter the first refrigerant via the dehumidifier expansion valve in such a matter that a desired temperature difference between the temperature of the air in the test space and the temperature of the dehumidifier heat exchanger is achieved. This temperature difference can be selected so that water from the air in the test space condenses on the dehumidifier heat exchanger. This makes it possible to carry out a targeted dehumidification of the air in the test space essentially independently of the yielding of a temperature in the test space. This means that the expansion valve and the dehumidifier expansion valve can be controlled independently of each other using the control device. A reduction in temperature in the test space can then, for example, be accompanied by a more or less strong dehumidification, whereby a relative air humidity can be set and/or regulated more precisely. Overall, a climatic test cycle can be carried out much more accurately with just a few components in a compact test chamber.

The dehumidifier bypass can be connected on a high-pressure side of the cooling circuit downstream of the gas cooler or the cascade heat exchanger and upstream of the expansion valve in the flow direction and on a low-pressure side of the first cooling circuit downstream of the heat exchanger and upstream of the compressor in the flow direction, refrigerant being able to be metered from the high-pressure side to the low-pressure side via the dehumidifier expansion valve in such a manner that the dehumidifier heat exchanger can be cooled. Optionally, it can also be intended that the dehumidifier bypass is connected to and/or formed by the second cooling circuit. The dehumidifier bypass can then be connected to an inlet flow of the second cooling circuit upstream of the cascade heat exchanger and to a return flow of the second cooling circuit downstream of the cascade heat exchanger and upstream of the pump.

By the temperature-control device, a relative air humidity ranging from 10% to 95%, preferably from 5% to 99%, at a temperature ranging from +10° C. to +90° C., preferably from +5° C. to +98° C., can be formed within the test space.

A regulating bypass having at least one regulating expansion valve can be formed in the first cooling circuit, the regulating bypass being able to be connected to the high-pressure side of the first cooling cycle downstream of the gas cooler and upstream of the expansion valve in the flow direction and to a low-pressure side of the first cooling cycle downstream of the heat exchanger and upstream of the compressor in the flow direction, a suction-gas temperature and/or a suction-gas pressure of the first refrigerant being able to be regulated in such manner on the low-pressure side of the first cooling cycle upstream of the compressor that first refrigerant can be metered in the low-pressure side via the regulating expansion valve. Optionally, it can be intended that the regulating bypass is connected to the high-pressure side downstream of the cascade heat exchanger in the first cooling circuit. By the regulating expansion valve, the suction-gas temperature and/or the suction pressure can be influenced in such a manner upstream of the compressor that a final compressor temperature of the compressor is within an operating range intended for the compressor. Hence, a suction gas temperature of the compressor can rise particularly sharply if a temperature in the test space is to be reduced from +180° C. to a low temperature. Since the heat exchanger is located in the test space, the first refrigerant can flow from the heat exchanger to the compressor at this temperature if the temperature in the test space is particularly high, for example +180° C. Before the heavily overheated first refrigerant is supplied to the compressor, it can be cooled by the first refrigerant metered via the regulating expansion valve.

Another regulating bypass having at least another regulating expansion valve can be formed in the first cooling cycle, the other regulating bypass being able to be connected to the high-pressure side of the first cooling cycle downstream of the compressor and upstream of the gas cooler in the flow direction and to the low-pressure side of the first cooling cycle downstream of the heat exchanger and upstream of the compressor in the flow direction, a suction-gas temperature and/or a suction-gas pressure of the first refrigerant being able to be regulated in such a manner on the low-pressure side of the first cooling cycle upstream of the compressor that first refrigerant can be metered in the low-pressure side via the other regulating expansion valve. Accordingly, the other regulating bypass can be designed such that the first refrigerant can be directed from the high-pressure side to the low-pressure side via the other regulating expansion valve. The first refrigerant can be superheated and/or gaseous. The introduction of superheated first refrigerant from the high-pressure side to the low-pressure side by the other regulating bypass is particularly advantageous if the first cooling circuit is operated in a load-free operating state. As the expansion valve is then only opened slightlyor rarely, there is a risk that the suction pressure upstream of the compressor drops too low. When using carbon dioxide as the first refrigerant, absolutely dry ice can form at a pressure below 5.16 bar, which could disrupt safe operation of the first cooling circuit and possibly damage the compressor. Since the other regulating bypass immediately downstream of the compressor can be used to supply highly superheated first refrigerant upstream of the compressor, the formation of dry ice can be effectively prevented. Furthermore, it is also possible to equalize a pressure difference between the high-pressure side and the low-pressure side of the first cooling circuit via the other regulating bypass, for example if the cooling element is not in operation and there is a risk that the first refrigerant is heated as a result of temperature equalization with an environment and an undesirably high pressure is generated in the first cooling circuit.

A temperature ranging from −40° C. to +150° C., preferably −50° C. to +180° C., can be yielded within the test space by the temperature-control device.

A test chamber, in particular a climate chamber for conditioning air, comprising a temperature-insulated test space sealable against an environment and configured to receive test materials and a temperature-control device for controlling the temperature of the test space, the temperature-control device yielding a temperature ranging from −20° C. to +150° C. within the test space, the temperature-control device having a cooling element having a first cooling cycle having a first refrigerant, a heat exchanger in the test space, a compressor, a gas cooler, a cascade heat exchanger and an expansion valve, the cascade heat exchanger being connected to a high-pressure side of the first cooling cycle, the cascade heat exchanger being coupled with a second cooling cycle of the cooling element, the test chamber having a control device for controlling and/or regulating the temperature in the test space, the first refrigerant being an unfluorinated refrigerant, preferably pure carbon dioxide, the second cooling cycle comprising a pump and a liquid as a heat carrier. With regard to the advantages of the test chamber according to the disclosure, reference is made to the description of the advantages of the method according to the disclosure.

The cascade heat exchanger can be connected on the high-pressure side of the first cooling cycle downstream of the gas cooler and upstream of the expansion valve in a flow direction of the first refrigerant. For example, the first refrigerant can then be advantageously liquefied in the cascade heat exchanger.

The second cooling cycle can be coupled with a second cascade heat exchanger of a third cooling cycle of the cooling element. The third cooling circuit can have a second refrigerant, the second cascade heat exchanger, a second compressor, a second gas cooler and a second expansion valve. The second refrigerant can be identical to or different from the first refrigerant. In principle, however, it is also possible for other means of generating a cooling capacity and/or dissipating thermal energy to be used instead of the third cooling circuit. Alternatively, the third cooling circuit can also be designed having a second pump and a second liquid as a second heat carrier. It is essential that the third cooling circuit can be used to dissipate thermal energy from the second cooling circuit.

A liquid bypass of the second cooling cycle can extend via the heat exchanger in the test space, the heat exchanger being able to be designed having a first exchanger body for the first cooling cycle and a second exchanger body for the second cooling cycle or a shared exchanger body for the first cooling circuit and the second cooling circuit. If the liquid bypass of the second cooling circuit extends via the test space, the test space can also be controlled in temperature by the second cooling circuit. The heat exchanger may have separate exchanger bodies for the corresponding cooling circuits or a shared exchanger body. An exchanger body may be a body which can, for example, be made in one or more parts and through which a refrigerant flows. This also includes tube arrangements which are provided with fins for better heat transfer. The lamellae then form the exchanger body together with the tube arrangement(s) tube. The exchanger body has a surface effective for heat transfer.

The temperature-control device can have a heating element having a heater and a thermal heat exchanger in the test space. The heating element can, for example, be an electrical resistance heater which heats the thermal heat exchanger in such a manner that a temperature increase in the test space is made possible via the thermal heat exchanger. If the heat exchanger and the thermal heat exchanger can be specifically controlled and/or regulated by the control device for cooling or heating the air circulating in the test space, a temperature in the temperature ranges specified above can then be yielded within the test space by the temperature-control device.

Further embodiments of a test chamber are derived from the descriptions of features of the dependent claims.

The system comprises a test chamber according to the disclosure and at least one other test chamber which comprises another temperature-insulated test space sealable against an environment and configured to receive test materials, and another temperature-control device for controlling the temperature of other test space, the other temperature-control device yielding a temperature ranging from −20° C. to +150° C. within the other test space, the other temperature-control device having another cooling element having another first cooling cycle having another first refrigerant, another heat exchanger in the other test space, another compressor, another gas cooler, another cascade heat exchanger and another expansion valve, the other cascade heat exchanger being connected to a high-pressure side of the other first cooling cycle, the other cascade heat exchanger being coupled with the second cooling cycle of the test chamber, the other test chamber having another control device for controlling and/or regulating the temperature in the other test space.

Accordingly, the system according to the dislcosure is formed at least from the test chamber according to the disclosure, which comprises the second cooling circuit, and the other test chamber. The other test chamber is connected to and/or coupled with the second cooling circuit of the test chamber via the other cascade heat exchanger integrated in the other first cooling circuit. The other cascade heat exchanger is switched in parallel with the second cooling circuit of the test chamber. This can be achieved by connecting the other cascade heat exchanger to an inlet flow and a return flow of the second cooling circuit via another bypass of the second cooling circuit. It can be intended that the other cascade heat exchanger can be supplied with the heat carrier in a regulated manner by another bypass valve element, preferably another bypass three-way valve. Advantageously, the already present second cooling circuit can be used by the other test chamber, as is already the case with the test chamber. It is then no longer necessary to provide a second cooling circuit which can only be used with the other test chamber for the additional test chamber. The system can also comprise three or more test chambers, in which case all other test chambers can be connected to the second cooling circuit of the test chamber. Overall, this makes it possible to utilize the advantages of the second cooling circuit for the other test chamber as well. This means that these test chambers can be operated particularly efficiently.

Further embodiments of a system are derived from the descriptions of features of the dependent claims.

### BRIEF DESCRIPTION OF THE FIGURES

In the following, a preferred embodiment of the disclosure is described in more detail with reference to the enclosed drawings.

FIG. 1 shows a schematic view of a first embodiment of a temperature-control

device.

FIG. 2 shows a schematic view of a second embodiment of a temperature-control device.

FIG. 3 shows a schematic view of a third embodiment of a temperature-control device.

FIG. 4 shows a schematic view of a fourth embodiment of a temperature-control device.

### DETAILED DESCRIPTION

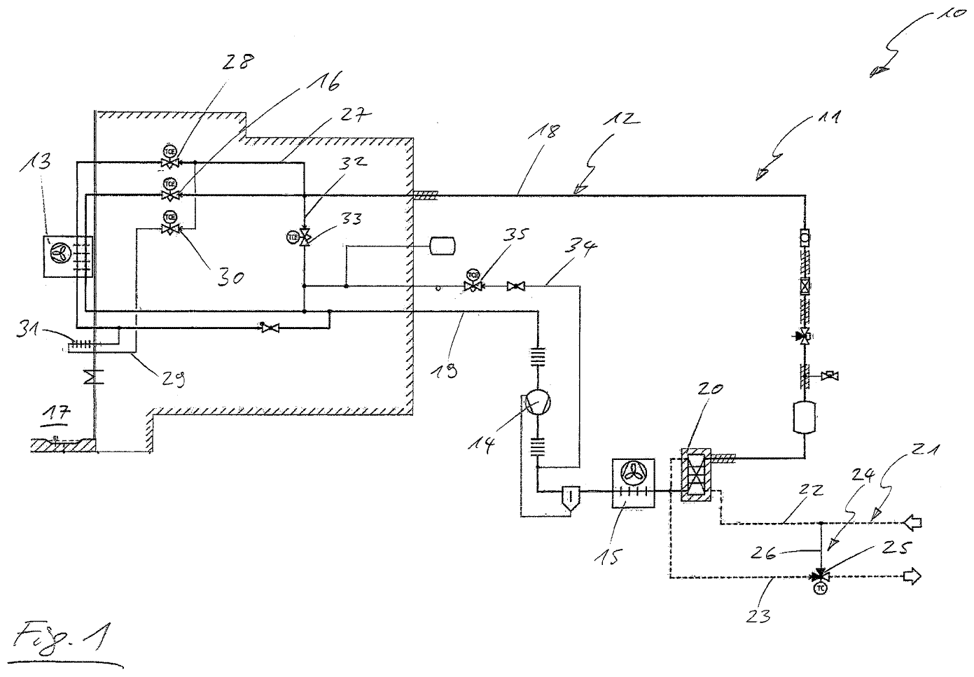

FIG. 1 shows a possible embodiment of a temperature-control device 10 of a test chamber (not shown). The temperature-control device 10 has a cooling element 11, which in turn forms a first cooling circuit 12 with carbon dioxide as a first refrigerant, a heat exchanger 13, a compressor 14, a gas cooler 15 and an expansion valve 16. The gas cooler 15 is designed here as a heat exchanger and/or condenser and is cooled via a heat carrier, such as air or water. The heat exchanger 13 is disposed in an air-treatment channel (not shown here) of a test space 17 of the test chamber in such a manner that air in the test space 17, which is circulated via the air-treatment channel, can be cooled by the heat exchanger 13. Furthermore, the first cooling circuit 12 has a high-pressure side 18 and a low-pressure side 19. In the low-pressure side 19, a pressure of the first refrigerant is comparatively lower than in the high-pressure side 18. The first cooling circuit 12 further comprises a cascade heat exchanger 20, which is connected to the first cooling circuit 12 downstream of the gas cooler 15 and upstream of the expansion valve 16 in a flow direction of the first refrigerant.

The cooling element 11 also has a second cooling circuit 21, which is also coupled with the cascade heat exchanger 20. The second cooling circuit 21 has a pump (not shown) and a liquid as a heat carrier which can be circulated in the second cooling circuit 21. The second cooling circuit 21 is then connected to the cascade heat exchanger 20 with an inlet flow 22 and a return flow 23. Furthermore, a valve element 24 is provided in the second cooling circuit 21, which is formed here by a three-way valve 25. The valve element 24 bridges the cascade heat exchanger 20 with a tube 26. The heat carrier can thus be guided past the cascade heat exchanger 20 from the three-way valve 25 via the tube 26, so that a mass flow of the heat carrier through the cascade heat exchanger 20 can be regulated in an advantageous manner.

Furthermore, a bypass 27 having a bypass expansion valve 28 is formed in the first cooling circuit 12. The bypass 27 extends via the heat exchanger 13 and is connected to the high-pressure side 18 downstream of the cascade heat exchanger 20 and upstream of the expansion valve 16 in the flow direction of the first refrigerant and to the low-pressure side 19 downstream of the heat exchanger 13 and upstream of the compressor 14 in the flow direction of the first refrigerant. The first cooling circuit 12 also has a dehumidifier bypass 29 having a dehumidifier expansion valve 30 and a dehumidifier heat exchanger 31 in the test space 17. The dehumidifier heat exchanger 31 can be used to dehumidify the air in the test space 17.

In addition, the first cooling circuit 12 is designed having a regulating bypass 32 having a regulating expansion valve 33 and another regulating bypass 34 having a further regulating expansion valve 35.

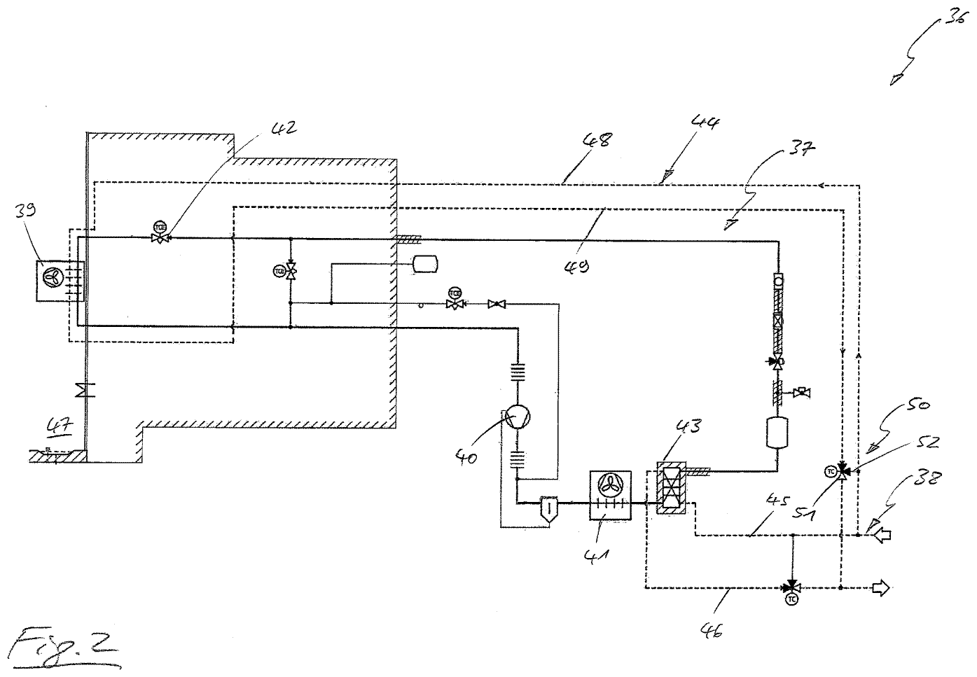

FIG. 2 shows an embodiment of a temperature-control device 36 with a first cooling circuit 37 and a second cooling circuit 38. The first cooling circuit 37 comprises a heat exchanger 39, a compressor 40, a gas cooler 41 and an expansion valve 42. Furthermore, the first cooling circuit 37 is coupled with the second cooling circuit 38 via a cascade heat exchanger 43. In contrast to the second cooling circuit 38 in FIG. 1, the second cooling circuit 38 is designed having a liquid bypass 44, which is connected to an inlet flow 45 and a return flow 46 of the second cooling circuit 48. The liquid bypass 44 extends via the heat exchanger 39, which is disposed in a test space 47. Thus, a temperature in the test space 47 can be yielded optionally by the first cooling circuit 37 and/or the second cooling circuit 38. A bypass valve element 50, which is formed by a bypass three-way valve, is provided between an inlet flow 48 and a return flow 49 of the liquid bypass 44. The bypass three-way valve 51 is disposed in the return flow 49 and connected to the inlet flow 48 via a tube 52, so that the heat carrier can be guided past the heat exchanger 39 via the tube 52 and thus a mass flow of heat carrier into the heat exchanger 39 can be regulated.

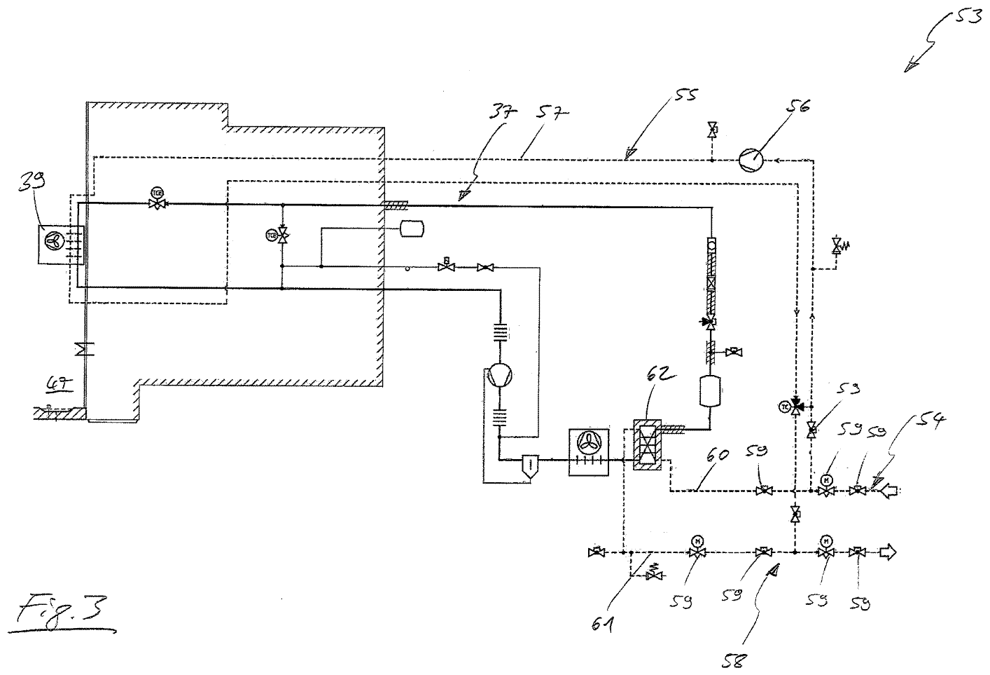

FIG. 3 shows a temperature-control device 53 which, in contrast to the temperature-control device in FIG. 2, has a second cooling circuit 54 which has a liquid bypass 55 having another pump 56. The other pump 56 is disposed in an inlet flow 57 of the liquid bypass 55. The second cooling circuit 54 has a valve element 58, which is formed from a plurality of switchable valves 59 in an inlet flow 60 and a return flow 61 of the second cooling circuit 54. A control device (not shown) of the temperature-control device 53 can switch and/or throttle the valves 59 in such a manner that a desired mass flow of heat carrier is set at a cascade heat exchanger 62.

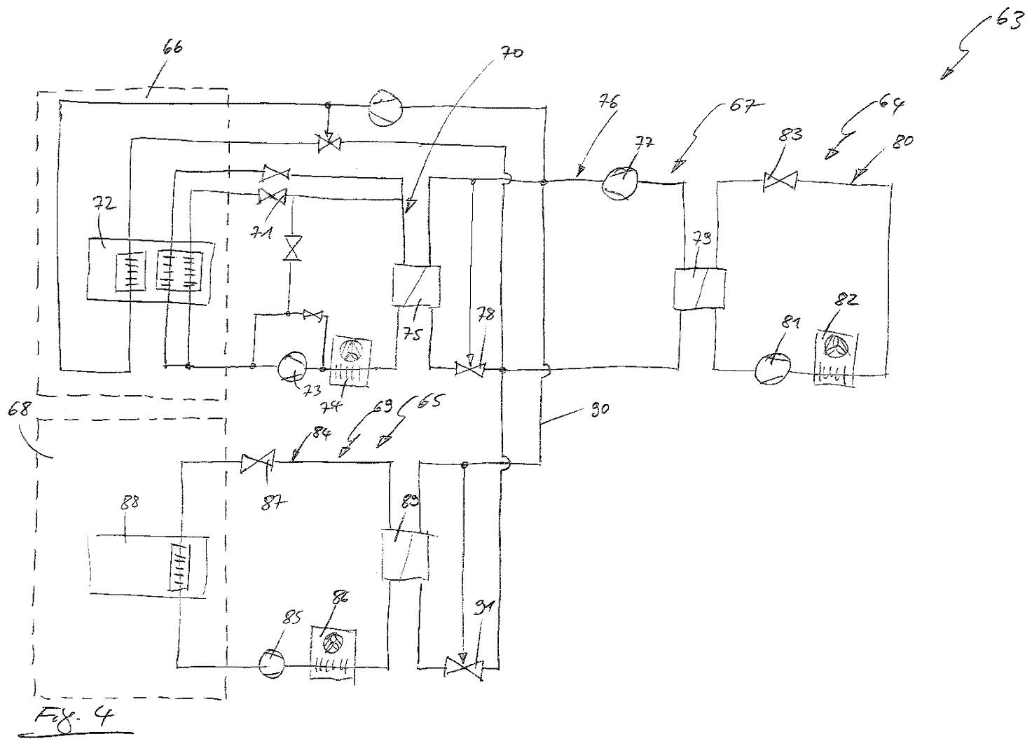

FIG. 4 shows a system 63 having a temperature-control device 64 of a test chamber (not shown in detail) and another temperature-control device 65 of another test chamber (also not shown in detail). The test chamber has a test space 66 (shown schematically) and a cooling element 67, and the other test chamber has another test space 68 and another cooling element 69. The cooling element 67 comprises a first cooling circuit 70 having an expansion valve 71, a heat exchanger 72 in the test space 66, a compressor 73, a gas cooler 74 and a cascade heat exchanger 75. A refrigerant of the first cooling circuit is carbon dioxide. The cooling element 67 also has a second cooling circuit 76, which is connected to the cascade heat exchanger 75 and has a pump 77 and a three-way valve 78 for regulating a mass flow of a heat carrier of the second cooling circuit 76. A second cascade heat exchanger 79 is also connected in the second cooling circuit 76. This in turn is coupled with a third cooling circuit 80 of the cooling element 67. The third cooling circuit 80 comprises a second compressor 81, a second gas cooler 81 and a second expansion valve 83. An unfluorinated refrigerant, for example carbon dioxide, is also provided here as a refrigerant. In principle, however, it is also possible to use other means for refrigeration instead of the third cooling circuit 80.

The other cooling element 69 has another first cooling circuit 84, which in turn comprises another compressor 85, another gas cooler 86, another expansion valve 87, another heat exchanger 88 in the other test space 68 and another cascade heat exchanger 89. A refrigerant in this instance is an unfluorinated refrigerant, such as pure carbon dioxide. The other cascade heat exchanger 89 is connected to the second cooling circuit 76 via another bypass 90. Another three-way valve 91 is provided in the other bypass 90, a mass flow of the heat carrier through the other cascade heat exchanger 89 being able to be regulated via the other three-way valve 91. In principle, like the other test chamber, other test chambers (not shown here) can be connected in parallel to the second cooling circuit 76 via the other bypass 90, each with a specially provided bypass. The second cooling circuit 76 can thus be used for a plurality of test chambers.

1. A method for conditioning air in a temperature-insulated test space of a test chamber, in particular a climate chamber, the test space being sealable against an environment and configured to receive test materials, a cooling element of a temperature-control device of the test chamber, a first cooling circuit having a first refrigerant, a heat exchanger in the test space, a compressor, a gas cooler, a cascade heat exchanger and an expansion valve yielding a temperature ranging from −20° C. to +150° C. within the test space, the cascade heat exchanger being connected to a high-pressure side of the first cooling circuit, the cascade heat exchanger being coupled with a second cooling circuit of the cooling element, the temperature in the test space being controlled and/or regulated by a control device of the test chamber,
wherein
the first refrigerant is an unfluorinated refrigerant, the second cooling circuit comprising a pump and a liquid as a heat carrier, the temperature being yielded within the test space.

2. The method according to claim 1,
wherein
the heat carrier is circulated in the second cooling circuit without a phase change.

3. The method according to claim 1,
wherein
the second cooling circuit has a valve element between an inlet flow and a return flow of the second cooling circuit, the valve element bridging the cascade heat exchanger a regulating element of the control device regulating a mass flow to the heat carrier via the cascade heat exchanger by the valve element.

4. The method according to claim 1,
wherein
a liquid bypass is formed in the second cooling circuit between an inlet flow and a return flow of the second cooling circuit, the liquid bypass extending via the heat exchanger, the temperature in the test space being yielded by the first cooling circuit and/or the second cooling circuit.

5. The method according to claim 4,
wherein
the liquid bypass has a bypass valve element between an inlet flow and a return flow of the liquid bypass, the bypass valve element bridging the heat exchanger, a regulating element of the control device regulating a mass flow of the heat carrier via the heat exchanger by the bypass valve element.

6. The method according to claim 4,
wherein
another pump by which the heat carrier is conveyed is disposed in the liquid bypass.

7. The method according to claim 1,
wherein
the expansion valve and/or a three-way valve each having a PID controller of a regulating element of the control device is regulated according to a temperature in the test space as a reference variable.

8. The method according to claim 1,
wherein
the control device operates the pump at a temperature of >0° C. in the test space as a reference variable and the compressor at a temperature of <0° C.

9. The method according to claim 1 ,
wherein
a rotational speed of the compressor and/or the pump is regulated.

10. The method according to claim 1,
wherein
the first cooling cycle is operated in a thermodynamically subcritical or transcritical operating state.

11. The method according to claim 1,
wherein
a bypass having at least one bypass expansion valve is formed in the first cooling cycle, the bypass extending via the heat exchanger and being connected to the high-pressure side of the first cooling cycle downstream of the gas cooler or the cascade heat exchanger and upstream of the expansion valve in the flow direction and to a low-pressure side of the first cooling cycle downstream of the heat exchanger and upstream of the compressor in the flow direction, the temperature in the test space being regulated in such manner that first refrigerant is metered in the heat exchanger via the bypass expansion valve.

12. The method according to claim 1,
wherein
air in the test space is dehumidified by a dehumidifier bypass, the first cooling cycle having a dehumidifier expansion valve or the second cooling cycle having a dehumidifier valve element and having a dehumidifier heat exchanger in the test space.

13. The method according to claim 1,
wherein
a regulating bypass having at least one regulating expansion valve is formed in the first cooling circuit, the regulating bypass being connected to the high-pressure side of the first cooling cycle downstream of the gas cooler and upstream of the expansion valve in the flow direction and to a low-pressure side of the first cooling cycle downstream of the heat exchanger and upstream of the compressor in the flow direction, a suction-gas temperature and/or a suction-gas pressure of the first refrigerant being regulated in such manner on the low-pressure side of the first cooling cycle upstream of the compressor that first refrigerant is metered in the low-pressure side via the regulating expansion valve.

14. The method according to claim 1,
wherein
another regulating bypass having at least another regulating expansion valve is formed in the first cooling cycle, the other regulating bypass being connected to the high-pressure side of the first cooling cycle downstream of the compressor and upstream of the gas cooler in the flow direction and to the low-pressure side of the first cooling cycle downstream of the heat exchanger and upstream of the compressor in the flow direction, a suction-gas temperature and/or a suction-gas pressure of the first refrigerant being regulated in such a manner on the low-pressure side of the first cooling cycle upstream of the compressor that first refrigerant is metered in the low-pressure side via the other regulating expansion valve.

15. The method according to claim 1,
wherein
a temperature ranging from −40° C. to +150° C. is yielded within the test space by the temperature-control device.

16. A test chamber, in particular a climate chamber for conditioning air, comprising a temperature-insulated test space sealable against an environment and configured to receive test materials and a temperature-control device for controlling the temperature of the test space, the temperature-control device yielding a temperature ranging from −20° C. to +150° C. within the test space, the temperature-control device having a cooling element having a first cooling cycle having a first refrigerant, a heat exchanger in the test space, a compressor, a gas cooler, a cascade heat exchanger and an expansion valve, the cascade heat exchanger being connected to a high-pressure side of the first cooling cycle, the cascade heat exchanger being coupled with a second cooling cycle of the cooling element, the test chamber having a control device for controlling and/or regulating the temperature in the test space,
wherein
the first refrigerant is an unfluorinated refrigerant, the second cooling cycle comprising a pump and a liquid as a heat carrier.

17. The test chamber according to claim 16,
wherein
the cascade heat exchanger is connected on the high-pressure side of the first cooling cycle downstream of the gas cooler and upstream of the expansion valve in a flow direction of the first refrigerant.

18. The test chamber according to claim 16,
wherein
the second cooling cycle is coupled with a second cascade heat exchanger of a third cooling cycle of the cooling element.

19. The test chamber according to claim 16,
wherein
a liquid bypass of the second cooling cycle extends via the heat exchanger in the test space, the heat exchanger having a first exchanger body for the first cooling cycle and a second exchanger body for the second cooling cycle or a shared exchanger body.

20. The test chamber according to claim 16,
wherein
the temperature-control device has a heating element having a heater and a thermal heat exchanger in the test space.

21. A system, comprising a test chamber according to claim 16 and at least one other test chamber, comprising another temperature-insulated test space sealable against an environment and configured to receive test materials, and another temperature-control device for controlling the temperature of other test space, the other temperature-control device yielding a temperature ranging from −20° C. to +150° C. within the other test space, the other temperature-control device having another cooling element having another first cooling cycle having another first refrigerant, another heat exchanger in the other test space, another compressor, another gas cooler, another cascade heat exchanger and another expansion valve, the other cascade heat exchanger being connected to a high-pressure side of the other first cooling cycle, the other cascade heat exchanger being coupled with the second cooling cycle of the test chamber, the other test chamber having another control device for controlling and/or regulating the temperature in the other test space.
